(19) United States
(12) Patent Application Publication
(10) Pub. No.: US 2007/0274307 A1
(43) Pub. Date: Nov. 29, 2007

(54) Cluster System, Cluster Member, And Program

(76) Inventors: Shuichi Karino, Tokyo (JP); Masahiro Jibiki, Tokyo (JP); Kazuya Suzuki, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 11/547,758

(22) PCT Filed: Apr. 15, 2005
(86) PCT No.: PCT/JP05/07310

§ 371 Date: Oct. 6, 2006

(30) Foreign Application Priority Data
Apr. 15, 2004 (JP) 120235/2004

(51) Int. Cl. H04L 12/56

(52) U.S. Cl. 370/389

(57) ABSTRACT

Each of cluster members (1-1) constituting a cluster system which functions as a router includes a session processor (15) and session state synchronization unit (16). If the session state of a session to which a packet input via a spare processing packet filter (13) belongs is not held in a session state holding unit (18), the session processor (15) newly registers the session state. When receiving a transfer rejection notification containing a session identifier of an unauthorized packet from a paired current cluster member, the session state synchronization unit (16) deletes a session state represented by the session identifier from the session state holding unit. If a cluster member which performs spare processing in a certain partial range has failed, the session state of this cluster member can be restored on a new cluster member added instead of the faulty cluster member, without largely increasing the communication cost.

### TECHNICAL FIELD

The present invention relates to a cluster system which functions as a router for transferring IP packets and a cluster member constituting the cluster system and, more particularly, to a cluster system and cluster member having a function of restoring the session state of the existing session on a cluster member newly added in place of a faulty cluster member.

### BACKGROUND ART

Routers installed in IP networks include devices which perform processing by referring to information of an upper layer of an IP layer. Examples are a firewall device used to interrupt unauthorized access, and a VPN gateway device which terminates an IPsec tunnel. Whenever receiving a packet, these devices identify the session of an upper layer to which the received packet belongs, and perform processing (e.g., unauthorized packet discarding) corresponding to the state (stored in an internal storage unit) of the identified session and the contents of the header of the received packet, resulting in a very large processing amount. Therefore, techniques (cluster systems) which distribute the load by preparing a plurality of devices have been developed.

A technique described in Japanese Patent Laid-Open No. 2003-517221 or 2003-518338 is known as prior art of the cluster system. As shown in FIG. 20, this conventional cluster system comprises one master router device 1200 and a plurality of router devices (slave router devices) 1201 to 120n. Each of the router devices 1200 to 120n incorporates a session processor and traffic distribution filter.

All the router devices 1200 to 120n receive an IP packet (to be also simply referred to as a packet hereinafter) from an adjacent IP node 1210 to the cluster system, by multicast using a data link layer protocol. The traffic distribution filter in each of the router devices 1200 to 120n passes or discards the IP packet multicast on a data link 1220, in accordance with traffic distribution rules.

The traffic distribution rules of the traffic distribution filter in each of the router devices 1200 to 120n satisfy the following conditions.

The same packet does not pass through the traffic distribution filters in a plurality of router devices.

A packet necessarily passes through the traffic distribution filter in one of the router devices.

The master router device 1200 sets the traffic distribution rules of the traffic distribution filters in the router devices 1201 to 120n. The master router device 1200 has detected the traffic distribution rules set in the traffic distribution filters in the router devices 1201 to 120n, and sets traffic distribution rules so as to evenly distribute the loads on the router devices 1201 to 120n. Also, the master router device 1200 incorporates a traffic distribution filter which processes a packet which does not apply to the traffic distribution rules. Furthermore, the master router device 1200 generates new traffic distribution rules from the session state of the processed packet, and sets the new rules in the traffic distribution filters of the router devices 1201 to 120n. Note that if the master router device 1200 fails, one of the router devices 1201 to 120n operates as a master router device.

The session processor in each of the router devices 1201 to 120n processes and discards or transfers a packet having passed through the packet distribution filter, by referring to session processing rules and session states set in the session processor.

The master router device 1200 sets the session processing rules of the session processors in the router devices 1201 to 120n. The router devices 1200 to 120n including the master router device 1200 exchange the session states indicating their own session states. The router devices 1200 to 120n perform this session state exchange for every predetermined time, and hold the session processing rules of the other router devices and the exchanged latest session states of the other router devices. If one of the router devices 1201 to 120n fails, therefore, the master router device 1200 can determine a substitute device and hand over the processing rules and session states set in the faulty router device to the substitute device. If the master router device 1200 fails, another router device can take over the processing of the master router device 1200.

### DISCLOSURE OF INVENTION

### Problem to be Solved by the Invention

In the prior art described above, the cluster system can automatically recover from a failure in any router device constituting the system. After this automatic recovery, however, another router device takes over processing which has been performed by the router device (faulty router device) in which the failure has occurred, so the load on the other router device increases. Although automatic recovery is possible, therefore, it is unfavorable to leave the cluster system to stand in the recovered state; it is desirable to add a normally operable router device (new router device) to the cluster system to return the number of devices to the original number.

The addition of a new router device requires the session state held by the faulty router device to be restored on the new router device. In the above prior art, the master router device communicates with the new router device to restore the session state on it. Unfortunately, this raises the communication cost because control information for acknowledgement or the like must be exchanged in addition to the session state.

It is, therefore, an object of the present invention to reduce the communication cost when restoring the session state on a newly added cluster member.

### Means for Solving the Problem

To achieve the above object, a cluster system according to the present invention is characterized by comprising a cluster member which performs current processing and a cluster member which performs spare processing for each of a plurality of partial ranges obtained by dividing a total range of traffics to be processed, wherein the cluster member which performs spare processing comprises session state holding means for holding a session state of a session to which a received packet belongs, session-dependent processing means for storing, in the session state holding means, a session state of a session to which a packet received in a partial range within which the cluster member performs spare processing belongs, if the session state of the session to which the packet belongs is not held in the session state holding means and the packet is a normal packet, and taking-over control means for allowing, if another cluster member which performs current processing in the partial range has failed, the session-dependent processing means to take over the processing which has been performed by the other cluster member by using the session state held in the session state holding means.

A cluster member according to the present invention is characterized by comprising session state holding means for holding a session state of a session to which a received packet belongs, session-dependent processing means for storing, in the session state holding means, a session state of a session to which a packet received in a partial range within which the cluster member performs spare processing belongs, if the session state of the session to which the packet belongs is not held in the session state holding means and the packet is a normal packet, and taking-over control means for allowing, if another cluster member which performs current processing in the partial range has failed, the session-dependent processing means to take over the processing which has been performed by the other cluster member by using the session state held in the session state holding means.

### EFFECTS OF THE INVENTION

In the present invention, when a normal packet is received in a partial range within which a cluster member performs spare processing, the session state holding means registers the session state of a session to which the packet belongs. Accordingly, if a cluster member which performs spare processing fails or if this cluster member disappears by taking over to current processing, the session state can be restored on a newly added cluster member which operates instead of the faulty or disappeared cluster member, without exchanging any control information for acknowledgement or the like. Therefore, the communication cost for restoring the session state can be reduced.

### BRIEF DESCRIPTION OF DRAWINGS

FIG. 1 is a block diagram showing an example of the overall configuration of the first embodiment of a cluster system according to the present invention;

FIG. 2 is a view showing the ranges of current processing and spare processing performed by cluster members 1-1 to 1-N;

FIG. 3 is a block diagram showing an example of the arrangement of the cluster member 1-1;

FIG. 4 is a block diagram showing the functions of a session processor 15;

FIG. 5 is a block diagram showing the functions of a session state synchronization unit 16;

FIG. 6 is a block diagram showing the functions of a health watchdog unit 20;

FIG. 7 is a flowchart showing an example of processing of the session processor 15 when a packet is input via a current processing packet filter 12;

FIG. 8 is a flowchart showing an example of processing of the session processor 15 when a packet is input via a spare processing packet filter 13;

FIG. 9 is a flowchart showing an example of a transfer rejection notification transmitting process performed by the session state synchronization unit 16 when receiving a session identifier from the session processor 15;

FIG. 10 is a flowchart showing an example of an empty transfer rejection notification transmitting process performed by the session state synchronization unit 16 for every predetermined time;

FIG. 11 is a flowchart showing an example of a session monitoring timer monitoring process performed by a session monitoring timer unit 17;

FIG. 12 is a flowchart showing an example of a member notice transmitting process performed by the health watchdog unit 20;

FIG. 13 is a flowchart showing an example of processing when the health watchdog unit 20 has received a member notice;

FIG. 14 is a flowchart showing an example of a health watchdog timer monitoring process performed by the health watchdog unit 20;

FIG. 15A is a view for explaining a restoration process when the cluster member 1-2 has failed;

FIG. 15B is a view for explaining the restoration process when the cluster member 1-2 has failed;

FIG. 15C is a view for explaining the restoration process when the cluster member 1-2 has failed;

FIG. 16 is a flowchart for explaining an example of processing when the session state synchronization unit 16 has received a transfer rejection notification from a paired current cluster member;

FIG. 17 is a block diagram showing an example of the arrangement of a cluster member 1-1a used in the second embodiment of the present invention;

FIG. 18 is a flowchart showing an example of processing when a session processor 15a has received a packet via a current processing packet filter 12;

FIG. 19 is a flowchart showing an example of processing when the session processor 15a has received a packet via a spare processing packet filter 13; and

FIG. 20 is a block diagram for explaining a prior art.

### BEST MODE FOR CARRYING OUT THE INVENTION

Embodiments of the present invention will be explained in detail below with reference to the accompanying drawings.

### Explanation of Arrangement of Embodiment

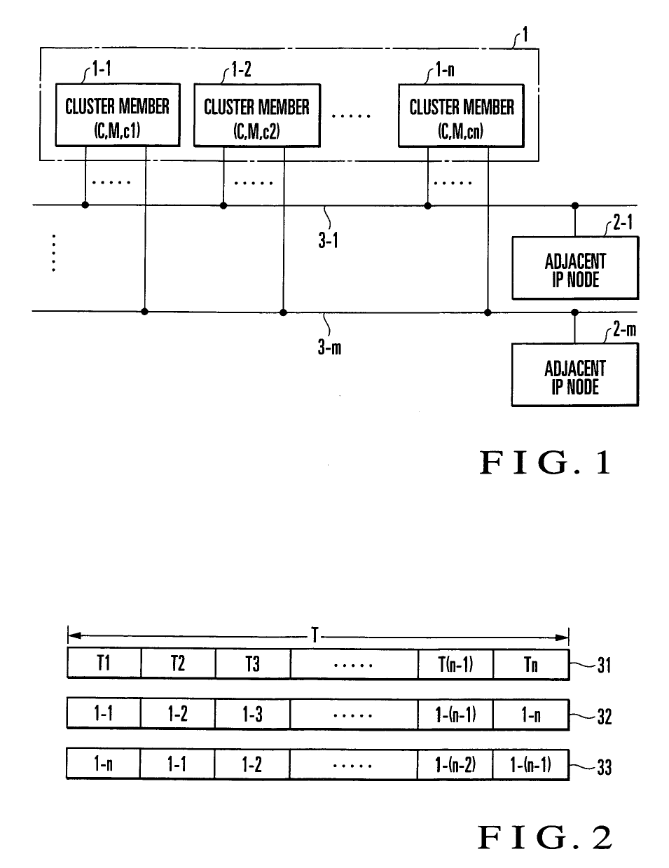

The first embodiment of the present invention will be explained below. As shown in FIG. 1, a cluster system 1 of this embodiment comprises n (a plurality of) cluster members 1-1 to 1-n. The cluster members 1-1 to 1-n connect to adjacent IP nodes 2-1 to 2-m via data links 3-1 to 3-m. The data links 3-1 to 3-m support multicast or broadcast.

A common cluster IP address “C” is allocated to the cluster members 1-1 to 1-n. The adjacent IP nodes 2-1 to 2-m detect the cluster system 1 as a single IP node having the cluster IP address “C”.

Also, a common cluster multicast MAC address “M” is allocated to the cluster members 1-1 to 1-n. The cluster system is preset to allow all the cluster members 1-1 to 1-n to receive a packet sent to the cluster multicast MAC address “M”.

Furthermore, individual IP addresses “c1” to “cn” are allocated to the cluster members 1-1 to 1-n, respectively. These IP addresses are used in, e.g., communications between the cluster members 1-1 to 1-nm.

The ranges of current processing and spare processing performed by the cluster members 1-1 to 1-n will be explained below with reference to FIG. 2. In this embodiment, as indicated by reference numeral 31, a total range T of traffics to be processed by the cluster system 1 is divided into n (the number of cluster members) partial ranges T1, T2, T3, . . . , Tn. The cluster members 1-1, 1-2, 1-3, . . . , 1-n perform current processing in the partial ranges T1, T2, T3, . . . , Tn as indicated by reference numeral 32, and perform spare processing in the partial ranges T2, T3, . . . , Tn, and T1 as indicated by reference numeral 33.

Note that it is desirable to determine the partial ranges T1 to Tn so as to equalize the loads on (equalize the numbers of packets to be processed by) the cluster members 1-1 to 1-n. An example is as follows. A commutative operation (e.g., addition or multiplication) is performed for the IP source address and IP destination address of a packet, and the operation result is divided by the number “n” of cluster members. Packets whose remainders are “0” to “n−1” are regarded as packets which belong to the partial ranges T1 to Tn, respectively.

Note also that the cluster members 1-1 to 1-n perform current processing and spare processing within the ranges shown in FIG. 2 in this embodiment, but the ranges are not limited to FIG. 2 and need only satisfy expressions (1) to (5) below. In expressions (1) to (5), mfi and bfi indicate the ranges within which a cluster member 1-i (1≦i≦n) performs current processing and spare processing, respectively, and Ø indicates an empty set.
mf1∪mf2∪ . . . ∪mfn=T (1)
mf1∩mf2∩ . . . ∩mfn=φ (2)
bf1∪bf2∪ . . . ∪bfn=T (3)
bf1∩bf2∩ . . . ∩bfn=φ (4)
bfi∩mfi=φ (5)

Although one cluster member performs current processing and spare processing in different partial ranges in this embodiment, one cluster member can also perform current processing or spare processing in one partial range. In this case, the number of cluster members must be twice that of partial ranges.

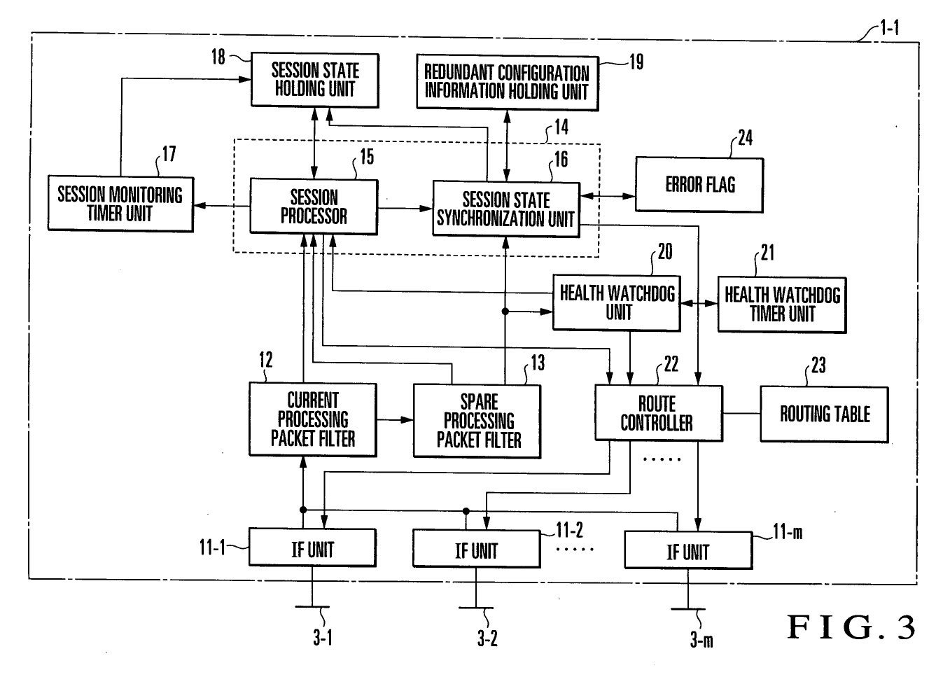

An example of the arrangement of the cluster member 1-1 will be explained below with reference to FIG. 3. The cluster member 1-1 comprises interface units (IF units) 11-1 to 11-n, a current processing packet filter 12, a spare processing packet filter 13, a session-dependent processor 14 including a session processor 15 and session state synchronization unit 16, session monitoring timer unit 17, a session state holding unit 18, a redundant configuration information holding unit 19, a health watchdog unit 20, a health watchdog timer unit 21, a route controller 22, and a routing table 23. Note that the cluster members 1-2 to 1-n also have the same arrangement as the cluster member 1-1.

The interface units 11-1 to 11-m connect to the data links 3-1 to 3-m, and transmit and receive packets and the like.

The current processing packet filter 12 has a function of transferring, to the session processor 15, packets in the partial range within which the cluster member 1-1 performs current processing, from packets and the like input from the interface units 11-1 to 11-m, and transferring other packets to the spare processing packet filter 13.

The spare packet filter 13 has a function of transferring, to the session processor 15, packets in the partial range within which the cluster member 1-1 performs spare processing, from the packets and the like transferred from the current processing packet filter 12, and outputting other packets to the session state holding unit 16 and health watchdog unit 20.

The session processor 15 performs the following processing when receiving packets from the current processing packet filter 12 and spare processing packet filter 13.

### Processing of Session Processor 15 when Packet is Transferred from Current Processing Packet Filter 12

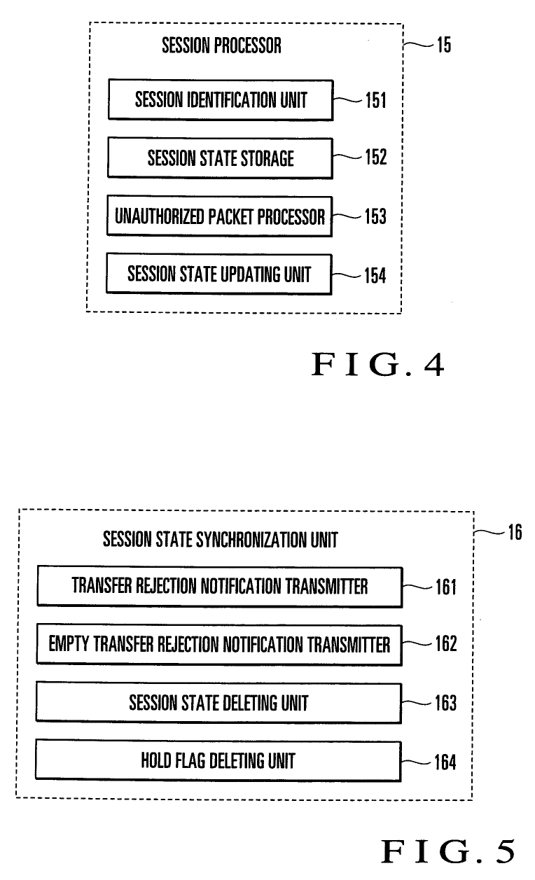

The session processor 15 identifies a session to which the packet belongs. This is the function of a session identification unit 151 shown in FIG. 4.

If the packet is a session establishment packet (e.g., a SYN packet of TCP), the session processor 15 registers, in the session state holding unit 18, the session identifier and session state of the session to which the packet belongs such that the session identifier and session state correspond to each other. This is the function of a session state storage 152 shown in FIG. 4.

If the packet is an unauthorized packet, the session processor 15 discards the packet, and notifies the session state synchronization unit 16 of the session identifier of the session to which this unauthorized packet belongs. This is the function of an unauthorized packet processor 153 shown in FIG. 4.

If the packet is a normal packet of the existing session, the session processor 15 updates the session state held in the session state holding unit 18, and transfers the packet to the route controller 22. This is the function of a session state updating unit 154 shown in FIG. 4.

### Processing of Session Processor 15 when Packet is Transferred from Spare Processing Packet Filter 13

The session processor 15 identifies a session to which the packet belongs. This is the function of the session identification unit 151 shown in FIG. 14.

If the packet is a session establishment packet, the session processor 15 registers, in the session state holding unit 18, the session identifier and session state of the session to which the packet belongs such that the session identifier and session state correspond to each other. After that, the session processor 15 discards the packet. This is the function of the session state storage 152 shown in FIG. 4.

If the packet belongs to the existing session, the session processor 15 updates the corresponding session state registered in the session state holding unit 18, and discards the packet. This is the function of the session state updating unit 154 shown in FIG. 4.

If the packet does not belong to the existing session, the session processor 15 registers, in the session state holding unit 18, the session identifier, session state, and hold flag (hold identifier) of the session to which the packet belongs such that the session identifier, session state, and hold flag correspond to each other, instructs the session monitoring timer unit 17 to set a session monitoring timer for the session, and discards the packet. This is the function of the session state storage 152 shown in FIG. 4.

A session herein mentioned indicates a virtual communication path provided by an IP extension protocol and upper layer protocol, and includes, e.g., a TCP connection and IPsec Security Association. A session state indicates information uniquely held for each session, and includes, e.g., the connection state, sequence number, and response number in the case of TCP connection. In the case of IPsec SA, the session state includes SA parameters defined by RFC2401.

If an error which may cause the cluster member 1-1 to overlook a packet occurs in the cluster member 1-1, an error detecting means (not shown) sets error flag=“1” in an error flag 24.

The session state synchronization unit 16 has the following functions.

When receiving the session identifier of a session to which a discarded packet belongs from the session processor 15, the session state synchronization unit 16 transmits a transfer rejection notification containing the session identifier and the value of the error flag 24 to a cluster member (to be also referred to as a paired spare cluster member hereinafter) which performs spare processing in the partial range within which the cluster member 1-1 performs current processing, and updates the error flag 24 to “0”. This is the function of a transfer rejection notification transmitter 161 shown in FIG. 5.

The session state synchronization unit 16 transmits, for every predetermined time, a transfer rejection notification (which contains no session identifier and will be also referred to as an empty transfer rejection notification hereinafter) containing the value of the error flag 24 to the paired spare cluster member, and updates the error flag 24 to “0”. This is the function of an empty transfer rejection notification transmitter 162 shown in FIG. 5.

When receiving a transfer rejection notification from a cluster member (to be also referred to as a paired current cluster member hereinafter) which performs current processing in the partial range within which the cluster member 1-1 performs spare processing, if an error flag contained in the notification is “1”, the session state synchronization unit 16 deletes the session state of a session specified by a session identifier contained in the transfer rejection notification, from the session states held in the session state holding unit 18. If the error flag is “0”, the session state synchronization unit 16 deletes the session state of the session specified by the session identifier contained in the transfer rejection notification, from the session states held in the session state holding unit 18, and also deletes the hold flag of a session state regarded as a hold flag delete candidate. In addition, the session state synchronization unit 16 holds, as a hold flag delete candidate, the session identifier of a session state to which a hold flag is attached. These are the functions of a session state deleting unit 163 and hold flag deleting unit 164 shown in FIG. 5.

The session monitoring timer unit 17 has a function of measuring a time from the time when a session state is registered in the session state holding unit 18, and deleting, from the session state holding unit 18, a session state to which a hold flag is kept attached for a predetermined time or more (i.e., the session state of a session corresponding to a timed-out session monitoring timer).

The redundant configuration information holding unit 19 stores the IP addresses of cluster members (a paired current cluster member and paired spare cluster member) having configurations redundant to the cluster member 1-1.

The health watchdog timer unit 21 has two health watchdog timers, i.e., a paired spare cluster member health watchdog timer (not shown) and paired current cluster member health watchdog timer (not shown).

The health watchdog unit 20 has the following functions.

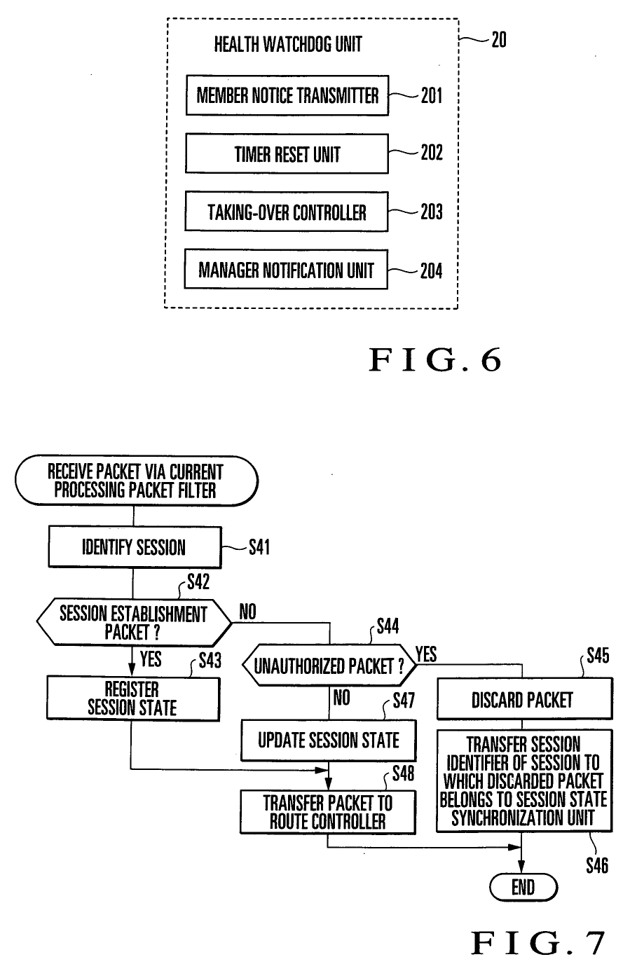

At each member notice transmission timing, the health watchdog unit 20 transmits a member notice to the paired spare cluster member and paired current cluster member. This is the function of a member notice transmitter 201 shown in FIG. 6.

When receiving a member notice from the paired spare cluster member or paired current cluster member, the health watchdog unit 20 instructs the health watchdog timer unit 21 to reset the corresponding health watchdog timer. This is the function of a timer reset unit 202 shown in FIG. 6.

When the paired current cluster member health watchdog timer has timed out, the health watchdog unit 20 notifies the session processor 15 that the spare processing packet filter 13 has switched to the current processing packet filter. That is, if the paired current cluster member has failed, the health watchdog unit 20 allows the session processor 15 to take over the processing which has been performed by the paired current cluster member, by using the session state held in the session state holding unit 18. This is the function of a taking-over controller 203 shown in FIG. 6.

When the paired spare cluster member health watchdog timer has timed out, the health watchdog unit 20 notifies the system manager of the information. This is the function of a manager notification unit 204 shown in FIG. 6.

The route controller 22 has a function of determining an interface unit to output a packet on the basis of the destination of a packet transferred from the session processor 15 and the contents of the routing table 23, and transferring the packet to the next hop via the interface unit.

Note that the cluster member 1-1 can be implemented by a computer and is implemented by a computer as follows. A disk, semiconductor memory, or another recording medium recording a cluster member program is prepared. A computer reads out the program to control its own operation, thereby implementing the interface units 11-1 to 11-m, current processing packet filter 12, spare processing packet filter 13, session-dependent processor 14, session monitoring timer unit 17, health watchdog unit 20, health watchdog timer unit 21, and route controller 22 on the computer.

### Explanation of Operation of Embodiment

The operation of this embodiment will be explained in detail below.

First, the relationship between the cluster system 1 and adjacent IP nodes 2-1 to 2-m will be explained with reference to FIG. 1. Each of the cluster members 1-1 to 1-n of the cluster system 1 returns the cluster multicast MAC address “M” as a response to an ARP message whose target is the cluster IP address “C”. Consequently, a data link frame containing a packet to be sent to the address “C” as the next hop by the adjacent IP nodes 2-1 to 2-m is sent to the address “M” and received by all the cluster members 1-1 to 1-n.

The operation of each of the cluster members 1-1 to 1-n in the cluster system 1 will be explained below. Note that the operations of the cluster members 1-1 to 1-n are the same, so the operation of a cluster member 1-i (1≦i≦n) will be explained as an example.

When receiving a packet (a packet from the adjacent IP nodes 2-1 to 2-m or a member notice or transfer rejection notification from the cluster members 1-2 to 1-n) via the interface units 11-1 to 11-n, the current processing packet filter 12 in the cluster member 1-i checks whether the packet belongs to a partial range within which the cluster member 1-i performs current processing. The current processing packet filter 12 transfers the packet to the session processor 15 if the packet belongs to the partial range, and transfers the packet to the spare processing packet filter 13 if the packet does not belong to the partial range.

When receiving the packet from the current processing packet filter 12, the spare processing packet filter 13 checks whether the packet belongs to a partial range within which the cluster member 1-i performs spare processing. The spare processing packet filter 13 transfers the packet to the session processor 15 if the packet belongs to the partial range, and outputs the packet (member notice or transfer rejection notification) to the session state synchronization unit 16 and health watchdog unit 20 if the packet does not belong to the partial range.

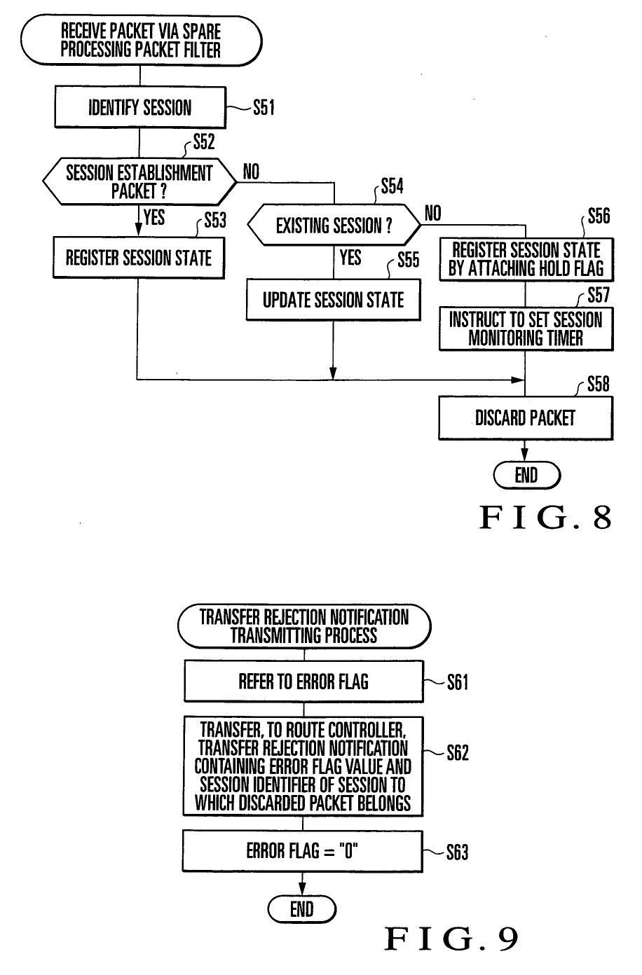

When receiving the packet from the current processing packet filter 12 or spare processing packet filter 13, the session processor 15 executes processing indicated by a flowchart shown in FIG. 7 or 8, respectively.

First, the operation when the session processor 15 has received the packet via the current processing packet filter 12 will be explained below with reference to FIG. 7.

When receiving the packet via the current processing packet filter 12, the session processor 15 first identifies a session to which the packet belongs (step S41 in FIG. 7). After that, the session processor 15 checks whether the packet is a session establishment packet (step S42).

If the packet is a session establishment packet (YES in step S42), the session processor 15 registers, in the session state holding unit 18, the session identifier of the session identified in step S41 and the session state of the session such that the session identifier and session state correspond to each other, and transfers the session establishment packet to the route controller 22 (steps S43 and S48). On the other hand, if the packet is not a session establishment packet (NO in step S42), the session processor 15 checks whether the packet is an unauthorized packet on the basis of header information of the packet and the session state of the corresponding session held in the session state holding unit 18 (step S44). Examples of the unauthorized packet are a packet whose session state is not held in the session state holding unit 18, and a packet whose header contents (header information) conflict with the session state held in the session state holding unit 18. Examples of the header information are the IP addresses of the destination and transmission source of the packet, and the port numbers of the destination and transmission source contained in the header of an upper layer (TCP or UDP).

If the session processor 15 determines that the packet is not an unauthorized packet but a normal packet (NO in step S44), the session processor 15 updates the corresponding session state registered in the session state holding unit 18 in accordance with the contents of the header of the input packet, and transfers the packet to the route controller 22 (steps S47 and S48). When receiving the packet, the route controller 22 determines an interface unit to output a packet on the basis the destination of the packet and the contents of the routing table 23, and transfers the packet to the next hop via the interface unit.

On the other hand, if the session processor 15 determines that the packet is an unauthorized packet (YES in step S44), the session processor 15 discards the packet and transfers the session identifier of the session to which the discarded packet belongs to the session state synchronization unit 16 (steps S45 and S46).

When receiving the session identifier from the session processor 15, the session state synchronization unit 16 first refers to the error flag 24 as shown in a flowchart of FIG. 9 (step S61). After that, the session state synchronization unit 16 transfers, to the route controller 22, a transfer rejection notification containing the value of the error flag 24 and the session identifier of the session to which the discarded packet belongs, and having the IP address of the paired spare cluster member as the destination, and updates the error flag 24 to “0” (steps S62 and S63). Note that the redundant configuration holding unit 19 holds the IP address of the paired spare cluster member.

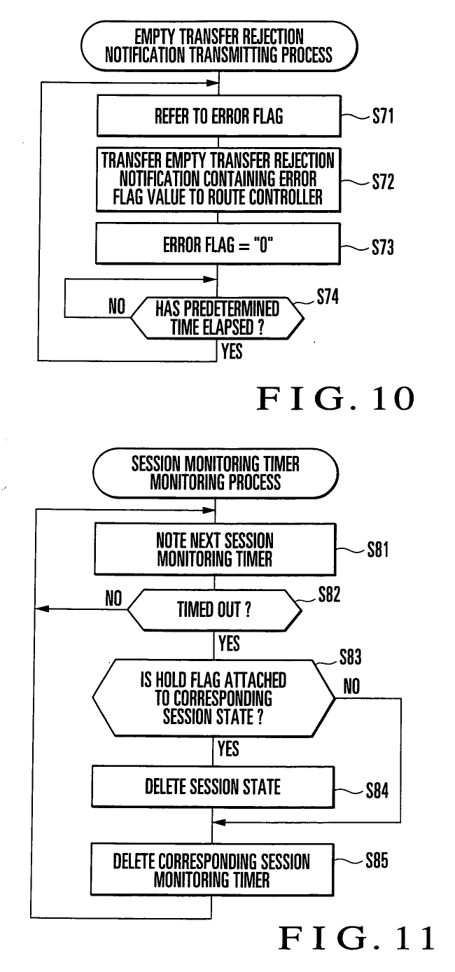

The session state synchronization unit 16 transmits a transfer rejection notification to the paired spare cluster member not only when receiving the session identifier of the session to which the discarded packet belongs from the session processor 15, but also whenever a predetermined time elapses. Referring to FIG. 10, the session state synchronization unit 16 transmits a transfer rejection notification (empty transfer rejection notification) containing the value of the error flag 24 but no session identifier to the paired spare cluster member whenever a predetermined time elapses (whenever step S74 is YES) (steps S71 and S72), and updates the value of the error flag 24 to “0”. Note that the predetermined time is shorter than the time-out time of a session monitoring timer (to be described later).

The operation when the session processor 15 has received the packet via the spare processing packet filter 13 will be explained below with reference to FIG. 8.

When receiving the packet via the spare processing packet filter 13, the session processor 15 first identifies a session to which the packet belongs (step S51 in FIG. 8). After that, the session processor 15 checks whether the packet is a session establishment packet (step S52).

If the packet is a session establishment packet (YES in step S52), the session processor 15 registers, in the session state holding unit 18, the session identifier of the session identified in step S51 and the session state of the session such that the session identifier and session state correspond to each other, and discards the packet (steps S53 and S58). On the other hand, if the packet is not a session establishment packet (NO in step S52), the session processor 15 checks whether the packet belongs to the existing session (step S54).

If the packet belongs to the existing session (YES in step S54), the session processor 15 updates the corresponding session state registered in the session state holding unit 18, and discards the packet (steps S55 and S58).

On the other hand, if the packet does not belong to the existing session (NO in step S54), the session processor 15 registers, in the session state holding unit 18, the session identifier of the session identified in step S51, the session state of the session, and the hold flag such that the session identifier, session state, and hold flag correspond to each other (step S56), instructs the session monitoring timer unit 17 to set a session monitoring timer for the session (step S57), and discards the packet (step S58).

In accordance with the instruction from the session processor 15, the session monitoring timer unit 17 sets the session monitoring timer (not shown) for the designated session. The session monitoring timer unit 17 also performs a session monitoring timer monitoring process shown in a flowchart of FIG. 11. Referring to FIG. 11, if there is a timed-out session monitoring timer among set session monitoring timers (no timer may be set in some cases) (YES in steps S81 and S82), the session monitoring timer unit 17 searches the session state holding unit 18 to check whether a hold flag is attached to the session state of a session corresponding to the session monitoring timer (step S83). If a hold flag is attached, the session monitoring timer unit 17 deletes the corresponding session state from the session state holding unit 18, and deletes the timed-out session monitoring timer (steps S84 and S85). If no hold flag is attached, the session monitoring timer unit 17 deletes the timed-out session monitoring timer (step S85). This process equally deletes session states to which hold flags are kept attached for a predetermined time or more.

The foregoing are the operations of the cluster member 1-i when the session processor 15 has received packets via the current processing packet filter 12 and spare processing packet filter 13.

When the cluster members 1-1 to 1-n execute the above operations, two cluster members which perform current processing and spare processing in the same partial range hold the same session state.

Processing performed by the cluster members 1-1 to 1-n to detect and restore failures of the paired spare cluster member and paired current cluster member will be explained below. This processing will be explained by taking the operation of the cluster member 1-i as an example.

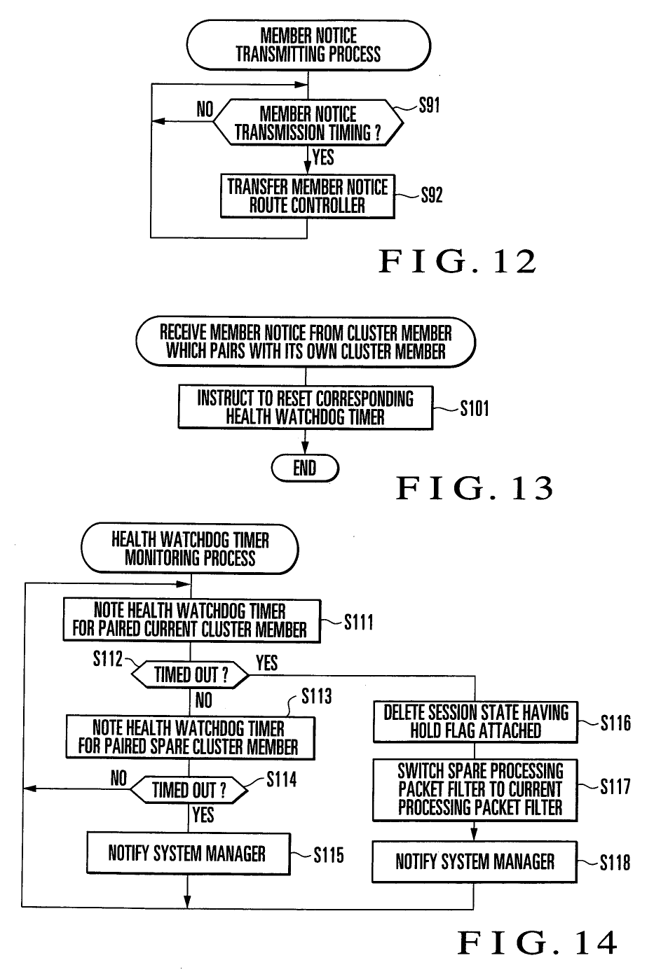

As shown in a flowchart of FIG. 12, the health watchdog unit 20 in the cluster member 1-i transfers a member notice to the route controller 22 at every member notice transmission timing (for every YES in step S91) (step S92). The member notice contains a member identifier which specifies the cluster member 1-i as a transmission source. The destination is an address (e.g., a cluster multicast MAC address) which can be received by the paired spare cluster member and paired current cluster member. When receiving the member notice from the health watchdog unit 20, the route controller 22 transmits the member notice to a data link 3-j (1≦j≦m) via an interface unit 11-j determined on the basis of the contents of the routing table 23.

The member notice received by the cluster member 1-i from another cluster member enters the health watchdog unit 20 via the current processing packet filter 12 and spare processing packet filter 13. If the transmission source of the input member notice is the paired current cluster member or paired spare cluster member, the health watchdog unit 20 instructs the health watchdog timer unit 21 to reset the corresponding health watchdog timer as shown in a flowchart of FIG. 13 (step S101). That is, if the transmission source is the paired current cluster member, the health watchdog unit 20 instructs the health watchdog timer unit 21 to reset the health watchdog timer for the paired current cluster member; if the transmission source is the paired spare cluster member, the health watchdog unit 20 instructs the health watchdog timer unit 21 to reset the health watchdog timer for the paired spare cluster member. In response to this instruction, the health watchdog timer unit 21 resets the designated health watchdog timer. Note that the health watchdog timer 20 discards a member notice sent from a cluster member other than the paired spare cluster member and paired current cluster member.

The health watchdog unit 20 also performs a health watchdog timer monitoring process shown in a flowchart of FIG. 14.

Referring to FIG. 14, the health watchdog unit 20 always monitors whether the health watchdog timer for the paired current cluster member or the health watchdog timer for the paired spare cluster member has timed out (steps S111 to S114). If the health watchdog timer for the paired spare cluster member has timed out (YES in step S114), the health watchdog unit 20 determines that the paired spare cluster member has failed, and notifies the system manager of this information by a system log or a message on the screen (step S115). If the health watchdog timer for the paired current cluster member has timed out (YES in step S112), the health watchdog timer 20 determines that the paired current cluster member has failed, and performs processing from step S116. In step S116, the health watchdog timer 20 deletes a session state to which a hold flag is attached, from the session states held in the session state holding unit 18 in the cluster member 1-i. In step S117, the health watchdog unit 20 notifies the session processor 15 that the spare processing packet filter 13 has switched to the current processing packet filter. In step S118, the health watchdog unit 20 notifies the system manager that the paired current cluster member has failed. Note that after being notified that the spare processing packet filter 13 has switched to the current processing packet filter, the session processor 15 performs the processing shown in the flowchart of FIG. 7 even for packets input via the spare processing packet filter 13. That is, if the paired current cluster member fails, the session processor 15 takes over current processing which has been performed by the faulty cluster member.

In this embodiment, if one cluster member fails, no cluster members perform spare processing an longer in two partial ranges. That is, no cluster members perform spare processing any longer in a partial range within which the faulty cluster member has performed spare processing and in a partial range within which the faulty cluster member has performed current processing.

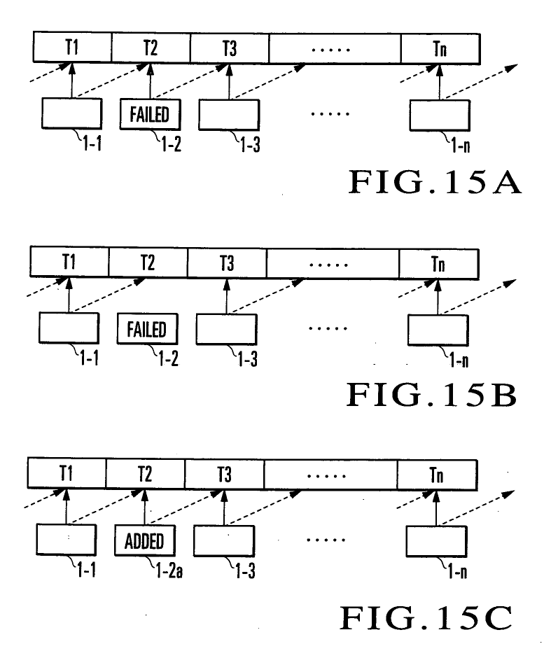

For example, if the cluster member 1-2 fails in the cluster system 1 while the cluster members 1-1, 1-2, . . . , 1-n perform current processing (indicated by the solid-line arrows) in the partial ranges T1, T2, . . . , Tn and spare processing (indicated by the broken-line arrows) in the partial ranges T2, T3, . . . , T1 as shown in FIG. 15A, no cluster members perform spare processing any longer in the partial range T2 within which the cluster member 1-2 has performed current processing and in the partial range T3 within which the cluster member 1-2 has performed spare processing as shown in FIG. 15B. Note that the cluster member 1-1 takes over the current processing in the partial range T2 within which the faulty cluster member 1-2 has performed the current processing.

In this case, as shown in FIG. 15C, the system manager adds, to the cluster system 1, a new cluster member 1-2a which performs current processing in the partial range T2 and spare processing in the partial range T3 in place of the faulty cluster member 1-2, and returns the state of the session processor 15 in the cluster member 1-1 which has taken over the current processing of the faulty cluster member 1-2 to the original state (for a packet input via the spare processing packet filter 13, the state in which the session processor 15 executes the processing shown in the flowchart of FIG. 8; the state in which the session processor 15 performs the spare processing in the partial range T2). Note that the newly added cluster member 1-2a has the same arrangement and functions as the faulty cluster member 1-2. When the cluster member 1-2a is added, however, no session states are registered in the session state holding unit 18 in the cluster member 1-2a.

The operation when the new cluster member 1-2a is added instead of the faulty cluster member 1-2 will be explained below.

If a packet input to the added cluster member 1-2a belongs to the partial range T2 within which the cluster member 1-2a performs current processing, this packet is input to the session processor 15 via the current processing packet filter 12. If the packet belongs to the partial range T3 within which the cluster member 1-2a performs spare processing, the packet is input to the session processor 15 via the spare processing packet filter 13. If the packet does not belong to either partial range, it is input to the session state synchronization unit 16 and health watchdog unit 20.

The session processor 15 executes the processing shown in the flowchart of FIG. 7 described above when receiving the packet via the current processing packet filter 12, and executes the processing shown in the flowchart of FIG. 8 when receiving the packet via the spare processing packet filter 13.

If the packet input via the spare processing packet filter 13 dos not belong to the existing session, i.e., if the packet belongs to a session whose session state is not held in the session state holding unit 18 (NO in step S54 of FIG. 8), the session processor 15 of the cluster member 1-2a registers, in the session state holding unit 18, the session identifier and session state of the session to which the packet belongs by attaching a hold flag to them, and instructs the session monitoring timer unit 17 to set a session monitoring timer corresponding to the session (steps S56 and S57).

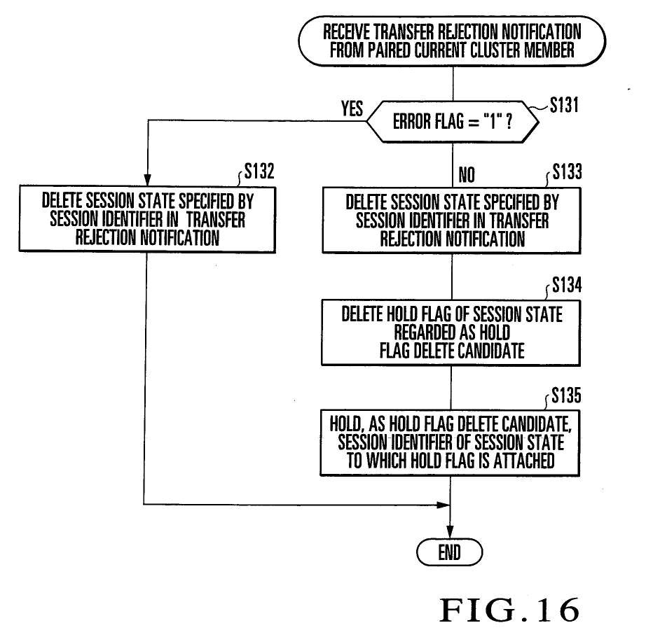

The session state of the session to which the packet belongs is thus registered in the session state holding unit 18 by attaching the hold flag for the reason explained below. That is, the cluster member 1-3 which performs current processing in the partial range T3 may have processed the packet as a normal packet which belongs to the existing session. If the packet is a normal packet which belongs to the existing session, processing shown in a flowchart of FIG. 16 performed by the session state synchronization unit 16 deletes the hold flag. If the packet is an unauthorized packet, the processing shown in the flowchart of FIG. 16 performed by the session state holding unit 16 deletes the session state, which is held in the session state holding unit 18, of the session to which the packet belongs. Also, the processing shown in the flowchart of FIG. 11 performed by the session monitoring timer unit 17 deletes the session state to which the hold flag is kept attached for a predetermined time or more.

When receiving, via the spare processing packet filter 13, a transfer rejection notification transmitted if the paired current cluster member (in this case, the cluster member 1-3) detects an unauthorized packet, the session state synchronization unit 16 in the cluster member 1-2a performs the processing shown in the flowchart of FIG. 16. First, the session state synchronization unit 16 checks whether an error flag contained in the transfer rejection notification is “1” or “0” (step S131).

If the error flag is “0”, i.e., if the cluster member 1-3 is normally operating (NO in step S131), the session state synchronization unit 16 deletes a session state specified by a session identifier in the transfer rejection notification, from the session states held in the session state holding unit 18 (step S133). This step deletes the session state concerning the unauthorized packet from the session state holding unit 18.

In this embodiment, the session state synchronization unit 16 regards a packet received by the cluster member 1-2a before this unauthorized packet as a normal packet in principle, and deletes a hold flag from the session state of a session to which the packet regarded as a normal packet belongs. In this case, the session state synchronization unit 16 regards, as a hold flag delete candidate, a session state with a hold flag held in the session state holding unit 18 after processing when the last transfer rejection notification is received, and deletes the hold flag of this session state as a candidate upon reception of the current transfer rejection notification (step S134).

Also, the session state synchronization unit 16 holds the session identifier of a session state with a hold flag, as a hold flag delete candidate, of the session states held in the session state holding unit 18 (step S135). Since this processing is performed, therefore, even if the session monitoring timer times out after that, the session state of a session to which a normal packet belongs is not deleted from the session state holding unit 18 because the hold flag is deleted from the session state.

If, however, the paired current cluster member 1-3 has overlooked an unauthorized packet and does not notify the cluster member 1-2a of the existence of this unauthorized packet by a transfer rejection notification, a hold flag is deleted from a session state pertaining to the unauthorized packet held in the cluster member 1-2a in response to a transfer rejection notification transmitted when the paired current cluster member 1-3 detects an unauthorized packet for the next time, so this session state is kept held.

To prevent this, if an error flag contained in a transfer rejection notification is “1”, i.e., if an error which may cause the paired current cluster member 1-3 to overlook a packet has occurred (YES in step S131), this embodiment performs only the process of deleting, from the session state holding unit 18, the session state of a session specified by a session identifier in the transfer rejection notification (step S132), and does not perform the processing after hold flag deletion. Even if the paired current cluster member 1-3 has overlooked an unauthorized packet, therefore, when the unauthorized packet is detected after that, the session state of this unauthorized packet can be deleted from the session state holding unit 18 of the cluster member 1-2a. Note that the session state synchronization units 16 in the other cluster members also perform the processing shown in the flowchart of FIG. 16.

In this embodiment as described above, the paired current cluster member 1-3 transmits a transfer rejection notification when detecting an unauthorized packet, and the cluster member 1-2a deletes a hold flag from the session state of a normal packet. Accordingly, this method keeps attaching a hold flag to the session state of a normal packet if no unauthorized packet is sent to at least the paired current cluster member 1-3. In addition, when the number of packets to be transferred by the paired current cluster member 1-3 increases, the possibility of packet overlooking rises, so an error flag contained in a transfer rejection notification is “1” even if an unauthorized packet is sent, and this makes it impossible to delete a hold flag. However, a hold flag is desirably deleted within as short a time as possible. This is so because if the paired current cluster member 1-3 fails and the cluster member 1-2a takes over the processing, all session states with hold flags must be discarded since the validity of any of these session states cannot be determined.

In this embodiment as described above, therefore, the paired current cluster member 1-3 periodically transmits an empty transfer rejection notification containing no session state identifier. If an error flag is “0” (YES in step S131), the cluster member 1-2a having received this empty transfer rejection notification deletes a hold flag attached to a session state as a hold flag delete candidate, and designates the next hold flag delete candidate, without performing the session state deleting process (steps S134 and S135). This improves the state in which a hold flag is kept attached for a long time.

The above processing allows the cluster member 1-2a to restore the session state concerning the partial range T3 and held by the cluster member 1-3 when a packet of the session is actually transferred.

### Another Embodiment

The second embodiment of the present invention will be explained below. This embodiment is characterized by making a transfer rejection notification unnecessary.

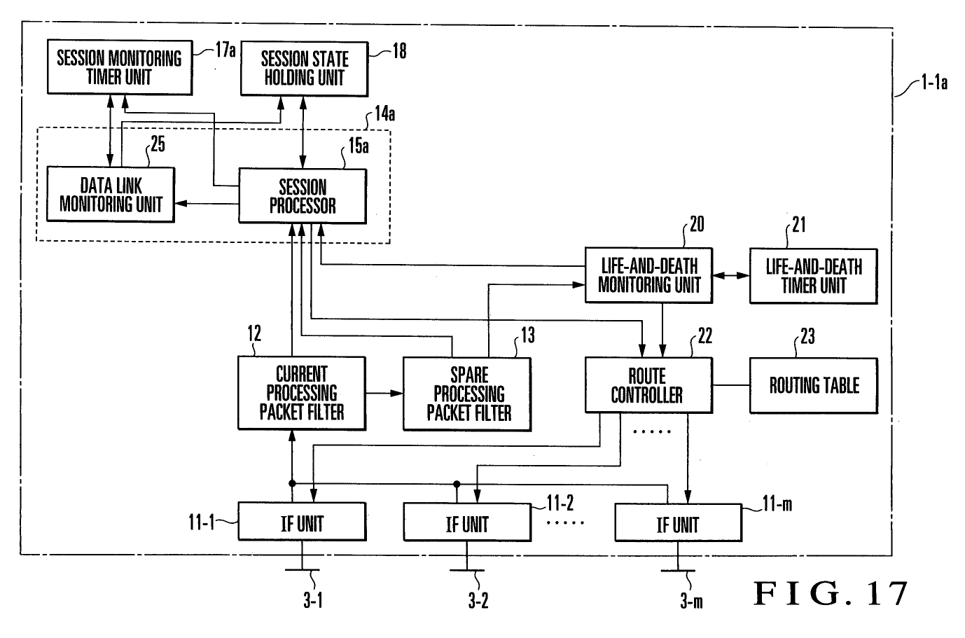

The differences of a cluster member 1-1a used in this embodiment shown in FIG. 17 and the cluster member 1-1 shown in FIG. 3 are that the cluster member 1-1a comprises a session-dependent processor 14a instead of the session-dependent processor 14 and a session monitoring timer unit 17a instead of the session monitoring timer unit 17, and comprises neither the redundant configuration information holding unit 19 nor error flag 24.

The differences of the session-dependent processor 14a from the session-dependent processor 14 are that the session-dependent processor 14a comprises a session processor 15a instead of the session processor 15, additionally has a data link monitoring unit 25, and does not comprise the session state synchronization unit 16.

Note that the cluster member 1-1a can be implemented by a computer and is implemented by a computer as follows. A disk, semiconductor memory, or another recording medium recording a cluster member program is prepared. A computer reads out the program to control its own operation, thereby implementing interface units 11-1 to 11-m, a current processing packet filter 12, a spare processing packet filter 13, the session-dependent processor 14a, the session monitoring timer unit 17a, a health watchdog unit 20, a health watchdog timer unit 21, and a route controller 22 on the computer.

The operation of this embodiment will be explained below. In this embodiment, only the differences from the first embodiment described above will be explained.

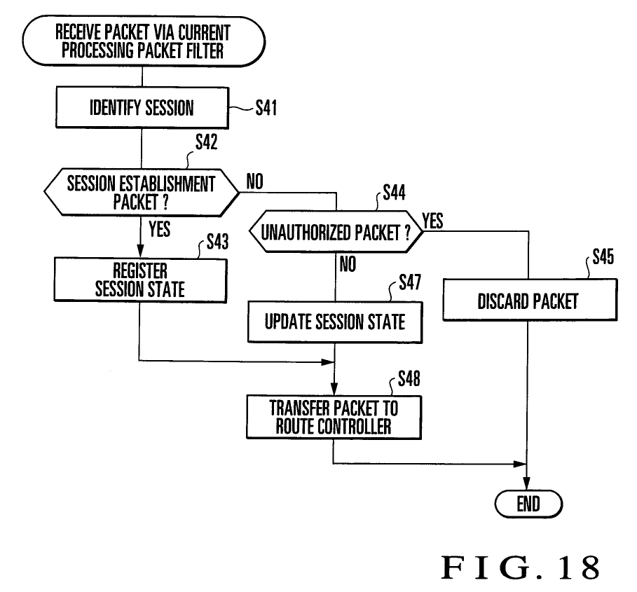

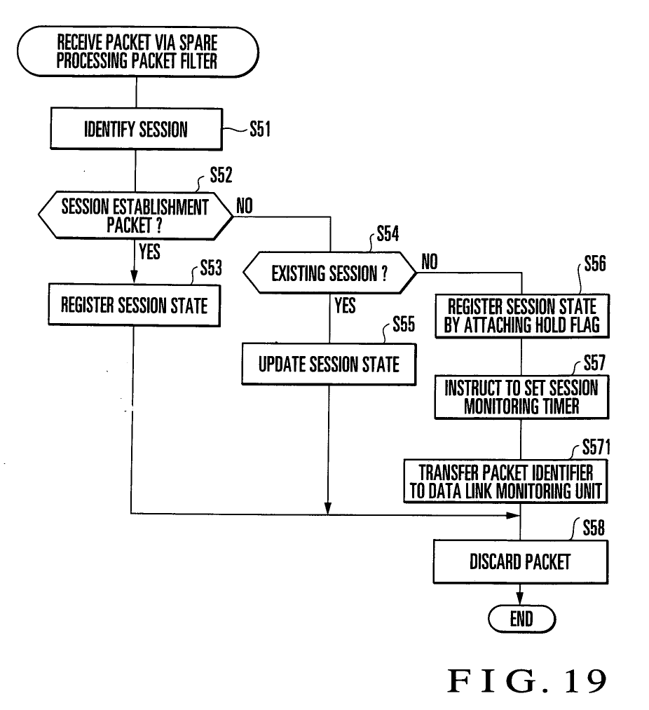

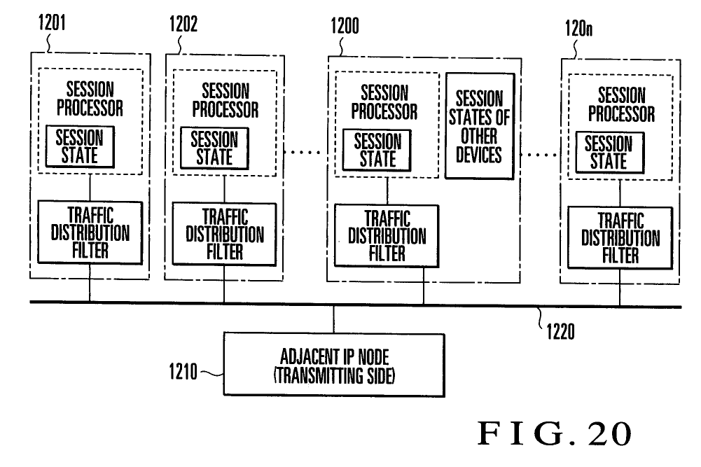

The session processor 15a performs processing shown in a flowchart of FIG. 18 when receiving a packet from the current processing packet filter 12, and performs processing shown in a flowchart of FIG. 19 when receiving a packet from the spare processing packet filter 13.

The flowchart shown in FIG. 18 is the same as that shown in FIG. 7 except that there is no step S46. That is, even when discarding a packet having passed through the current processing packet filter 12, this embodiment transmits no transfer rejection notification to a paired spare cluster member unlike in the first embodiment.

The flowchart shown in FIG. 19 is the same as that shown in FIG. 8 except that step S571 is added between steps S57 and S58. That is, if a packet input via the spare processing packet filter 13 is neither a session establishment packet nor a packet which belongs to the existing session (NO in step S54), this embodiment transfers the packet identifier of the packet to the data link monitoring unit 25 (step S571) in addition to the processes (steps S56 and S57) performed in the first embodiment. Note that this embodiment performs the process of registering, in a session state holding unit 18, the session state and session identifier of a session to which the packet belongs by attaching a hold flag to them in step S56, and performs the process of instructing the session monitoring timer unit 17a to set a session monitoring timer corresponding to the session in step S57 (this process allows the session monitoring timer 17a to start time measurement).

The data link monitoring unit 25 monitors a data link on the transmitting side. When detecting a packet having a packet identifier transferred from the session processor 15a (when a packet is transferred to the next hop), the data link monitoring unit 25 deletes a session monitoring timer for a session to which the packet belongs (this stops the time measurement by the session monitoring timer unit 17a), and deletes a hold flag from the session state of the session held in the session state holding unit 18. If the data link monitoring unit 25 is unable to detect a packet having the packet identifier, a session monitoring timer set in the session monitoring timer unit 17a and corresponding to a session to which the packet belongs times out, thereby deleting the session state of the session held in the session state holding unit 18.

The cluster member of this embodiment performs the above processing. When a new cluster member is added in place of a faulty cluster member, therefore, the same session state as a session state concerning a partial range within which the new cluster member performs spare processing, and held in a cluster member (paired current cluster member) which performs current processing, can be restored on the new cluster member. Unlike in the first embodiment, this embodiment obviates the need to transmit any transfer rejection notification from the paired current cluster member to the new cluster member, thereby further reducing the communication cost.

1. A cluster system characterized by comprising a cluster member which performs current processing and a cluster member which performs spare processing for each of a plurality of partial ranges obtained by dividing a total range of traffics to be processed, wherein
said cluster member which performs spare processing comprises:
session state holding means for holding a session state of a session to which a received packet belongs;
session-dependent processing means for storing, in said session state holding means, a session state of a session to which a packet received in a partial range within which said cluster member performs spare processing belongs, if the session state of the session to which the packet belongs is not held in said session state holding means and the packet is a normal packet; and
taking-over control means for allowing, if another cluster member which performs current processing in the partial range has failed, said session-dependent processing means to take over the processing which has been performed by said another cluster member by using the session state held in said session state holding means.

2. A cluster system according to claim 1, characterized in that said cluster member is added instead of a cluster member which has disappeared while the system is in operation.

3. A cluster system according to claim 1, characterized in that said cluster member which performs current processing comprises:
unauthorized packet processing means for discarding an unauthorized packet received in a partial range within which said cluster member performs current processing; and
transfer rejection notification transmitting means for transmitting a transfer rejection notification containing a session identifier which specifies a session to which the discarded packet belongs, and
said session-dependent processing means of said cluster member which performs spare processing comprises:
session state storage means for storing, in said session state holding means, a session state of a session to which a packet received in a partial range within which said cluster member performs spare processing belongs, if the session state of the session to which the packet belongs is not held in said session state holding means; and
session state deleting means for deleting, when receiving the transfer rejection notification, a session state of a session specified by a session identifier contained in the transfer rejection notification, from session states held in said session state holding means.

4. A cluster system according to claim 1, characterized in that said session-dependent processing means of said cluster member which performs spare processing comprises:
session state storage means for storing, in said session state holding means, a session state of a session to which a packet received in a partial range within which said cluster member performs spare processing belongs, if the session state of the session to which the packet belongs is not held in said session state holding means;
session monitoring timer means for measuring a time since the session state is held in said session state holding means, and deleting the session state from said session state holding means when a predetermined time has elapsed; and
data link monitoring means for detecting that a cluster member which performs current processing in the partial range has transferred the packet to a next hop, and stopping the time measurement by said session monitoring timer means.

5. A cluster system according to claim 1, characterized in that said session-dependent processing means of said cluster member which performs spare processing comprises:
session state storage means for storing, in said session state holding means, a session state of a session to which a packet received in a partial range within which said cluster member performs spare processing belongs, together with a hold identifier, if the session state of the session to which the packet belongs is not held in said session state holding means; and
session monitoring timer means for measuring a time since the session state is held in said session state holding means, and deleting the session state to which the hold identifier is attached from said session state holding means when a predetermined time has elapsed.

6. A cluster member according to claim 5, characterized in that said cluster member which performs current processing comprises:
unauthorized packet processing means for discarding an unauthorized packet received in a partial range within which said cluster member performs current processing; and
transfer rejection notification transmitting means for transmitting a transfer rejection notification containing a session identifier which specifies a session to which the discarded packet belongs, and
said session-dependent processing means of said cluster member which performs spare processing further comprises session state deleting means for deleting, when receiving the transfer rejection notification, a session state of a session specified by a session identifier contained in the transfer rejection notification, from session states held in said session state holding means.

7. A cluster system according to claim 6, characterized in that said session-dependent processing means of said cluster member which performs spare processing further comprises hold identifier deleting means for deleting, when receiving the transfer rejection notification, the hold identifier from a session state which is held in said session state holding means except for the session state deleted by said session state deleting means, and to which the hold identifier is attached.

8. A cluster system according to claim 7, characterized in that said transfer rejection notification transmitting means of said cluster member which performs current processing adds an error identifier to the transfer rejection notification if an error which may cause said cluster member to overlook a packet occurs in said cluster member, and
said hold identifier deleting means of said cluster member which performs spare processing does not delete the hold identifier if the error identifier is added to the received transfer rejection notification.

9. A cluster system according to claim 5, characterized in that said cluster member which performs current processing further comprises empty transfer rejection notification transmitting means for transmitting an empty transfer rejection notification containing no session identifier at a time interval shorter than the predetermined time on the basis of which said session monitoring timer means deletes the session state, and
said session-dependent processing means of said cluster member which performs spare processing further comprises hold identifier deleting means for deleting the hold identifier from the session state held in said session state holding means, when receiving the empty transfer rejection notification from another cluster member which performs current processing in a partial range within which said cluster member performs spare processing.

10. A cluster member according to claim 5, characterized in that said session-dependent processing means of said cluster member which performs spare processing further comprises data link monitoring means for detecting that a cluster member which performs current processing in the partial range has transferred the packet to a next hop, and deleting the hold identifier from a session state of a session to which the packet belongs.

11. A cluster system according to claim 1, characterized in that said cluster member which performs current processing further comprises member notice transmitting means for transmitting, at a predetermined timing, a member notice to another cluster member which performs spare processing in a partial range within which said cluster member performs current processing, and
said taking-over control means of said cluster member which performs spare processing comprises means for taking over processing of another cluster member which performs current processing in a partial range within which said cluster member performs spare processing, if no member notice is received for not less than a predetermined time from said another cluster member.

12. A cluster member characterized by comprising:
session state holding means for holding a session state of a session to which a received packet belongs;
session-dependent processing means for storing, in said session state holding means, a session state of a session to which a packet received in a partial range within which the cluster member performs spare processing belongs, if the session state of the session to which the packet belongs is not held in said session state holding means and the packet is a normal packet; and
taking-over control means for allowing, if another cluster member which performs current processing in the partial range has failed, said session-dependent processing means to take over the processing which has been performed by said another cluster member by using the session state held in said session state holding means.

13. A cluster member according to claim 12, characterized in that said session-dependent processing means comprises:
unauthorized packet processing means for discarding an unauthorized packet received in a partial range within which the cluster member performs current processing;
transfer rejection notification transmitting means for transmitting a transfer rejection notification containing a session identifier which specifies a session to which the discarded packet belongs;
session state storage means for storing, in said session state holding means, a session state of a session to which a packet received in a partial range within which the cluster member performs spare processing belongs, if the session state of the session to which the packet belongs is not held in said session state holding means; and
session state deleting means for deleting, when receiving a transfer rejection notification from another cluster member which performs current processing in a partial range within which the cluster member performs spare processing, a session state of a session specified by a session identifier contained in the transfer rejection notification, from session states held in said session state holding means.

14. A cluster member according to claim 12, characterized in that said session-dependent processing means comprises:
session state storage means for storing, in said session state holding means, a session state of a session to which a packet received in a partial range within which the cluster member performs spare processing belongs, if the session state of the session to which the packet belongs is not held in said session state holding means;
session monitoring timer means for measuring a time since the session state is held in said session state holding means, and deleting the session state from said session state holding means when a predetermined time has elapsed; and
data link monitoring means for detecting that a cluster member which performs current processing in the partial range has transferred the packet to a next hop, and stopping the time measurement by said session monitoring timer means.

15. A program which causes a computer to implement:
session state holding means for holding a session state of a session to which a received packet belongs;
session-dependent processing means for storing, in said session state holding means, a session state of a session to which a packet received in a partial range within which a cluster member performs spare processing belongs, if the session state of the session to which the packet belongs is not held in said session state holding means and the packet is a normal packet; and
taking-over control means for allowing, if another cluster member which performs current processing in the partial range has failed, said session-dependent processing means to take over the processing which has been performed by said another cluster member by using the session state held in said session state holding means.

16. A program according to claim 15, characterized in that as said session-dependent processing means, the program causes a computer to implement:
unauthorized packet processing means for discarding an unauthorized packet received in a partial range within which the cluster member performs current processing;
transfer rejection notification transmitting means for transmitting a transfer rejection notification containing a session identifier which specifies a session to which the discarded packet belongs;
session state storage means for storing, in said session state holding means, a session state of a session to which a packet received in a partial range within which the cluster member performs spare processing belongs, if the session state of the session to which the packet belongs is not held in said session state holding means; and
session state deleting means for deleting, when receiving a transfer rejection notification from another cluster member which performs current processing in a partial range within which the cluster member performs spare processing, a session state of a session specified by a session identifier contained in the transfer rejection notification, from session states held in said session state holding means.

17. A program according to claim 15, characterized in that as said session-dependent processing means, the program causes a computer to implement:
session state storage means for storing, in said session state holding means, a session state of a session to which a packet received in a partial range within which the cluster member performs spare processing belongs, if the session state of the session to which the packet belongs is not held in said session state holding means;
session monitoring timer means for measuring a time since the session state is held in said session state holding means, and deleting the session state from said session state holding means when a predetermined time has elapsed; and
data link monitoring means for detecting that a cluster member which performs current processing in the partial range has transferred the packet to a next hop, and stopping the time measurement by said session monitoring timer means.

18. A cluster system characterized by comprising a cluster member which performs current processing and a cluster member which performs spare processing for each of a plurality of partial ranges obtained by dividing a total range of traffics to be processed, wherein said cluster member which performs spare processing comprises:
session state holding means for holding a session state of a session to which a received packet belongs;
session-dependent processing means for storing, in said session state holding means, a session state of a session to which a packet received in a partial range within which said cluster member performs spare processing belongs, if the session state of the session to which the packet belongs is not held in said session state holding means and a current cluster member corresponding to said cluster member which performs spare processing determines that the packet is a normal packet; and
taking-over control means for allowing, if another cluster member which performs current processing in the partial range has failed, said session-dependent processing means to take over the processing which has been performed by said another cluster member by using the session state held in said session state holding means.
